(19) United States
(12) Patent Application Publication
(10) Pub. No.: US 2025/0383928 A1
(43) Pub. Date: Dec. 18, 2025

(54) METHOD FOR SORTING RESOURCES, ELECTRONIC DEVICE AND STORAGE MEDIUM

(71) Applicant: Beijing Baidu Netcom Science Technology Co., Ltd., Beijing (CN)

(72) Inventors: Wenbin Lu, Beijing (CN); Yuqi Lu, Beijing (CN); Huaxi Yin, Beijing (CN); Jinghao Peng, Beijing (CN)

(21) Appl. No.: 18/980,482

(22) Filed: Dec. 13, 2024

(30) Foreign Application Priority Data
Jun. 13, 2024 (CN) 202410763948.6

(51) Int. Cl. G06F 9/50

(52) U.S. Cl. CPC G06F 9/5038; G06F 9/5077; G06F 9/5033

(57) ABSTRACT

Provided is a method for sorting resources, an electronic device and a storage medium, relating to the field of artificial intelligence technology, and specifically to the fields of intelligent search, information flow, intelligent question and answer, and other technologies. The method includes: determining a state feature of a target object; matching the state feature with a plurality of candidate state categories of the target object to obtain a matched candidate state category as a target state category; and adjusting a resource order in a candidate resource set of the target object based on a target resource feature of the target object associated with the target state category.

### CROSS-REFERENCE TO RELATED APPLICATIONS

The present application claims priority to Chinese Patent Application No. CN202410763948.6, filed with the China National Intellectual Property Administration on Jun. 13, 2024, the disclosure of which is hereby incorporated herein by reference in its entirety.

### TECHNICAL FIELD

The present disclosure relates to the field of artificial intelligence technology, and specifically to the fields of intelligent search, information flow, intelligent question and answer, and other technologies.

### BACKGROUND

In an information retrieval and recommendation system, it is necessary to search for required resources from massive resources. During implementation, it is generally necessary to screen out some resources and then sort the resources. The purpose of resource sorting is mainly to screen out resources strongly related to requirements and then utilize the resources. For example, resources are recommended to users in order so that the users can obtain the required resources as quickly as possible. It can be seen that resource sorting is particularly important in the information retrieval and recommendation system.

### SUMMARY

The present disclosure provides a method and an apparatus for sorting resources, a device and a storage medium.

According to an aspect of the present disclosure, provided is a method for sorting resources, including:
determining a state feature of a target object;
matching the state feature with a plurality of candidate state categories of the target object to obtain a matched candidate state category as a target state category; and
adjusting a resource order in a candidate resource set of the target object based on a target resource feature of the target object associated with the target state category.

According to another aspect of the present disclosure, provided is an apparatus for sorting resources, including:
a determining module configured to determine a state feature of a target object;
a matching module configured to match the state feature with a plurality of candidate state categories of the target object to obtain a matched candidate state category as a target state category; and
an adjustment module configured to adjust a resource order in a candidate resource set of the target object based on a target resource feature of the target object associated with the target state category.

According to yet another aspect of the present disclosure, provided is an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

According to yet another aspect of the present disclosure, provided is a non-transitory computer-readable storage medium storing a computer instruction thereon, and the computer instruction is used to cause a computer to execute the method according to any one of the embodiments of the present disclosure.

According to yet another aspect of the present disclosure, provided is a computer program product including a computer program, and the computer program implements the method according to any one of the embodiments of the present disclosure, when executed by a processor.

In the embodiment of the present disclosure, matching is performed based on the state feature of the target object and the plurality of candidate state categories to determine the current state of the target object as the target state category. Then, the resource order in the candidate resource set of the target object is adjusted based on the target resource feature of the target object associated with the target state category, to match the demand for resources under the current state of the target object, thereby improving the accuracy of resource sorting.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic flow chart of a method for sorting resources according to an embodiment of the present disclosure;

FIG. 2 is a schematic flow chart of obtaining candidate state categories according to an embodiment of the present disclosure;

FIG. 3 is a schematic flow chart of obtaining a target resource feature according to an embodiment of the present disclosure;

FIG. 4 is a schematic diagram of determining a first resource graph according to an embodiment of the present disclosure;

FIG. 5 is a schematic diagram of a framework of a method for sorting resources according to an embodiment of the present disclosure;

FIG. 6 is a structural schematic diagram of an apparatus for sorting resources according to an embodiment of the present disclosure; and

FIG. 7 is a block diagram of an electronic device for implementing a method for sorting resources of the embodiment of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

The terms “first”, “second” and the like in the present disclosure are used to distinguish the similar objects, but not necessarily to describe a particular order or sequence. In addition, the terms “include” and “have” and any variations thereof are intended to cover a non-exclusive inclusion. For example, a method, system, product or device containing a series of steps or units is not necessarily limited to those steps or units listed clearly, but may include other steps or units that are not listed clearly or that are inherent to the process, method, product or device.

In the technical solution of the present disclosure, the acquisition, storage and application of the user's personal information involved are in compliance with relevant laws and regulations, and do not violate public order and good customs.

An embodiment of the present disclosure provides a method for sorting resources. The method for sorting resources provided in the embodiment of the present disclosure is applicable to any scenario where resource sorting is required based on the requirements of a target object. For example, this method is not only applicable to an information recommendation system, but also to an intelligent question answering system.

For example, in the information recommendation system, a plurality of required resources may be screened out based on the requirements of the target object, and then the method for sorting resources provided in the embodiment of the present disclosure is used to fine-tune the order based on the fact that the information recommendation system sorts resources, and then the resources are recommended to the target object. The information recommendation system may be a news recommendation system or a video recommendation system, etc.

For another example, in the intelligent question answering system, a plurality of resources may be screened out from a large amount of resources based on the question description, and then these resources are sorted, or these resources are re-sorted if these resources have already been sorted, so that the intelligent question answering system can understand the resources in the order in which the resources are sorted and generate answers.

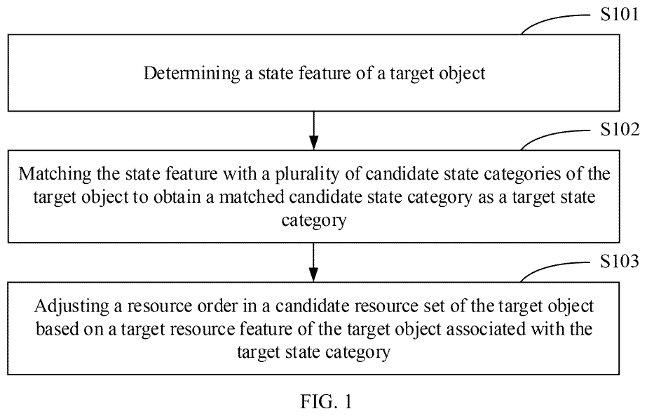

As shown in FIG. 1, it is a schematic flow chart of a method for sorting resources according to the embodiment of the present disclosure, including the following steps.

S101: a state feature of a target object is determined.

Here, the target object may be any user using a terminal device, and the terminal device includes but is not limited to a desktop computer, a mobile phone, a mobile computer, a tablet computer, a media player, a smart wearable device, a smart TV and other electronic devices.

The state feature is used to describe the current state of the target object, to facilitate understanding of the current demand of the target object for resource type.

S102: the state feature is matched with a plurality of candidate state categories of the target object to obtain a matched candidate state category as a target state category.

Here, the plurality of candidate state categories are used to describe several possible states of the target object. The requirements on resources are different in different states. Therefore, the use of candidate state categories can more accurately characterize the demand of the target object, thereby locating the real demand of the target object for resources.

S103: a resource order in a candidate resource set of the target object is adjusted based on a target resource feature of the target object associated with the target state category.

In the embodiment of the present disclosure, the resources in the candidate resource set may be sorted resources, for example, the candidate resource set is outputted in the sorting stage of the information recommendation system. Of course, the resources in the candidate resource set may also be unsorted resources. After the target resources are adjusted to their rough sorting in the embodiment of the present disclosure, the resource sorting is further optimized in the sorting stage of the recommendation system. Even more, in the resource sorting stage, the original sorting factors of the recommendation system may be used in combination with the target resource feature and the features of the resources in the candidate resource set in the embodiment of the present disclosure to perform comprehensive sorting.

In the embodiment of the present disclosure, matching is performed based on the state feature of the target object and the plurality of candidate state categories to determine the current state of the target object as the target state category. Then, the resource order in the candidate resource set of the target object is adjusted based on the target resource feature of the target object associated with the target state category, to match the demand for resources under the current state of the target object, thereby improving the accuracy of resource sorting.

The embodiment of the present disclosure includes the following content.

First, a plurality of candidate state categories of the target object are determined, then the target state category of the target object is determined, and then the resource order in the candidate resource set is adjusted based on the target resource feature of the target object associated with the target state category.

For further understanding, the above processes proposed in the embodiment of the present disclosure will be introduced below respectively, as follows:

### 1) Determining a Plurality of Candidate State Categories of the Target Object

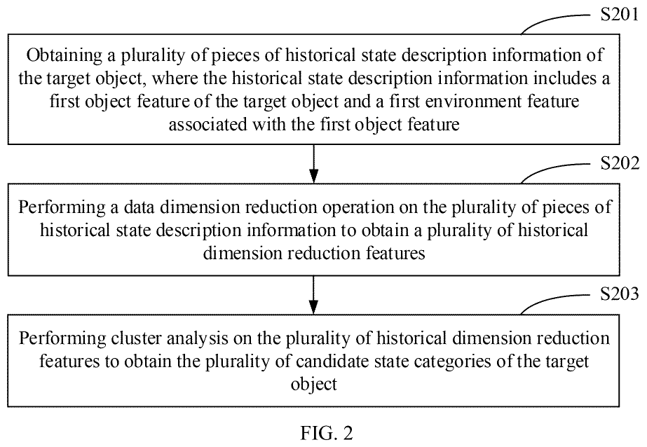

In some embodiments, the plurality of candidate state categories of the target object may be determined in the following manner, as shown in FIG. 2, including:

S201: obtaining a plurality of pieces of historical state description information of the target object, where the historical state description information includes a first object feature of the target object and a first environment feature associated with the first object feature.

Here, the plurality of pieces of historical state description information may be historical state description information within a first preset time period, that is, long-term historical state description information, so as to facilitate sorting out implicit candidate state categories of the target state.

Here, the first object feature of the target object is used to describe the closely-related environment information of the target object. Exemplarily, the first object feature includes, but is not limited to, the network state of the target object, geographical information, gyroscope information of a device used by the target object, and the like.

Here, the first environment feature may be understood as a general environment state. Exemplarily, the first environment feature includes, but is not limited to, network distribution volume of at least one content service, page view of each type of resource, and the like.

During implementation, the first object feature and the first environment feature are time-related, which can be specifically understood as: the first object feature and the first environment feature generated in the same time period are associated. They may be stored in the form of a key-value table (key-value pair), with a time period as Key and the first object feature and the first environment feature within the time period as Value. An exemplary storage form is shown in Table 1:

TABLE 1

| Key | Value | |
|---|---|---|
| Time period A | First object feature A | First environment feature A |
| Time period B | First object feature B | First environment feature B |
| . . . | . . . | . . . |

Moreover, in addition to associating the first object feature and the first environment feature based on the time period, the first object feature and the first environment feature may also be associated based on the geographical location, which can be understood as: the first object feature and the first environment feature belonging to the same time period and the same geographical location are associated.

Due to the inference ability and working mechanism of the neural network model, it is difficult to effectively analyze and understand implicit features of different state categories of the target object from the historical state description information. This may be because the neural network model only cares about a direct relationship between the target object and resource with ignoring the role of the state, or the features of the state are masked by other feature information. Regardless of the reason, it is proposed in the embodiment of the present disclosure to use a more explicit method to analyze and organize data in order to accurately understand the implicit feature of the state of the target object. Specifically, considering that the state is not single original feature data and cannot be directly expressed and described using natural language, a data dimension reduction operation is performed on the plurality of historical state description information to obtain a plurality of historical dimension reduction features in S202 of the embodiment of the present disclosure.

In some embodiments, the step of performing the data dimension reduction operation on the plurality of historical state description information to obtain the plurality of historical dimension reduction features, includes: performing the data dimension reduction operation on the plurality of historical state description information based on Principal Component Analysis (PCA) to obtain the plurality of historical dimension reduction features.

In some embodiments, the step of performing the data dimension reduction operation on the plurality of historical state description information to obtain the plurality of historical dimension reduction features, includes: performing the data dimension reduction operation on the plurality of historical state description information based on Canonical Correlation Analysis (CCA) to obtain the plurality of historical dimension reduction features.

In the embodiments of the present disclosure, the manner to perform dimension reduction on the historical state description information may be determined based on actual conditions, so as to mine the key feature that can implicitly express the state.

S203: cluster analysis is performed on the plurality of historical dimension reduction features to obtain the plurality of candidate state categories of the target object.

In some embodiments, the Mini Batch K-Means algorithm may be used to perform cluster analysis on the historical dimension reduction features to obtain the plurality of candidate state categories of the target object.

During specific implementation, some data are randomly extracted from the plurality of historical dimension reduction features as a sample set, and K cluster points are constructed using the K-Means algorithm (clustering algorithm); then some data are randomly extracted from the remaining data of the plurality of historical dimension reduction features except the sample set as a new sample set, and the K cluster points are trained based on the new sample set to update the center point of the cluster; the above operation is performed repeatedly until the center point is stable or the number of iterations is reached. The calculation operation is stopped, and K cluster points are obtained. The K cluster points are K candidate state categories, where K is a positive integer.

In the embodiment of the present disclosure, the dimension reduction operation is performed based on the historical state description information of the target object, so that the key information can be mined from a large amount of original information, and then the division of state categories is completed through cluster analysis. These state categories may include categories that are difficult to describe and understand in natural language, thereby obtaining implicit feature expression of the state of the target object. This provides a better data basis for subsequent resource sorting to improve the accuracy of sorting.

It can be understood that the more information dimensions and the more detailed the information content included in the historical state description information of the target object, the more candidate state categories will be obtained through analysis, and vice versa. During implementation, the information content in the historical state description information may be determined based on actual conditions.

In order to facilitate rapid determination of the target resource feature of the target object under the target state category, corresponding resource features may be periodically determined for each candidate state category in the embodiment of the present disclosure, which will be introduced below based on the content in 2).

### 2) Determining the Resource Feature of the Target Object Associated With Each Candidate State Category

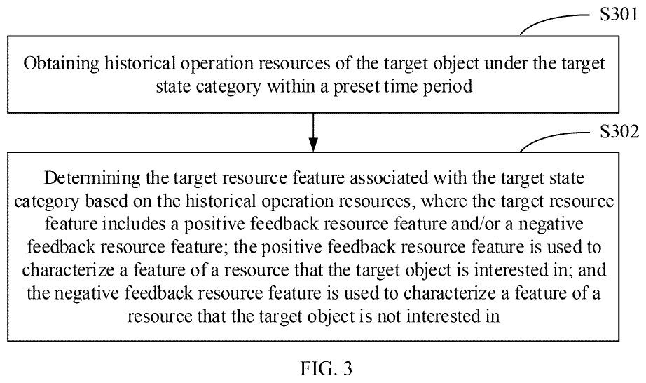

In some embodiments, taking the target state category as an example, the target resource feature of the target object associated with the target state category may be determined in the following manner, as shown in FIG. 3, which may be implemented as follows.

S301: historical operation resources of the target object under the target state category within a preset time period are obtained.

Here, the preset time period is much less than the first preset time period, and may be much greater than the second preset time period. The historical operation resources within the preset time period reflect the short-term resource preference of the target object. During implementation, the preset time period may be 7 days, 3 days, etc., which may be determined based on actual conditions.

Here, the historical operation resources may be understood as resources that the target object has operated under the target state category, such as resources that have been browsed, liked, collected, disliked, commented on, etc.

S302: the target resource feature associated with the target state category is determined based on the historical operation resources, where the target resource feature includes a positive feedback resource feature and/or a negative feedback resource feature; the positive feedback resource feature is used to characterize a feature of a resource that the target object is interested in; and the negative feedback resource feature is used to characterize a feature of a resource that the target object is not interested in.

It should be noted that the manner to determine the resource feature of each of the candidate state categories is the same as that of the target state category, and will not be repeated here.

It can be understood that, during implementation, the resource feature of the target object under each candidate state category can be determined in advance in order to improve the processing efficiency before the current state feature of the target object is determined, so that the target resource feature under the target state category can be quickly queried when the target state category of the target object is determined.

Alternatively, after the target state category is determined, the target resource feature that can describe the short-term demand characteristics of the target object is determined based on the method of FIG. 3.

In the embodiment of the present disclosure, the historical operation resources within the preset time period are used to sort out the short-term demand of the target object, so as to track the change in the demand of the target object and reasonably determine the corresponding target resource feature under this state. The target resource feature determined in this manner can characterize the short-term interest preference of the target object under the target state category, so as to achieve resource sorting centered on the demand of the target object and improve the accuracy of sorting.

In some embodiments, the target resource feature includes a positive feedback resource feature and/or a negative feedback resource feature. It can be understood that the positive feedback resource feature may be determined as the target resource feature or the negative feedback resource feature may be determined as the target resource feature. Of course, in order to achieve accurate adjustment of the recommended order of candidate resources, the positive feedback resource feature and the negative feedback resource feature may also be determined as target resource features. The following is a detailed description of how to obtain the positive feedback resource feature and the negative feedback resource feature:

### A) Obtaining the Positive Feedback Resource Feature

In some embodiments, the step of determining the positive feedback resource feature based on the historical operation resources may be implemented as follows.

Step B1: a plurality of first sub-resource features that the target object is interested in are extracted from a plurality of positive feedback resources in the historical operation resources; where the positive feedback resources are resources that the target object is interested in.

Here, the positive feedback resources may be resources that the target object likes, collects, or browses for a long time, that is, resources of interest.

In some embodiments, the step of extracting the plurality of first sub-resource features that the target object is interested in from the plurality of positive feedback resources in the historical operation resources may be implemented as follows.

Step B11: a first resource graph is constructed based on the plurality of positive feedback resources, where the positive feedback resources are used as nodes in the first resource graph, and access time sequences between the positive feedback resources are used as connection edges between the nodes.

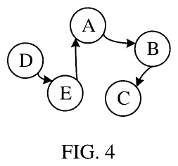

During implementation, since the resources within the preset time period are obtained, more positive feedback resources may be obtained when the preset time period is 7 days. Therefore, the positive feedback resources within the preset time period may be divided according to the third preset time period, to obtain a plurality of positive feedback resource sequences. An exemplary third preset time period may be 30 minutes, which can be understood as generating one positive feedback resource sequence every 30 minutes. For example, the positive feedback resources that the target object is interested in are A, B and C in the first 30 minutes; the positive feedback resources that the target object is interested in are D, E and A in the second 30 minutes; and so on. The analyzed first resource graph is shown in FIG. 4.

Step B12: a plurality of first resource sequences are extracted from the first resource graph using a random walk strategy.

Still taking FIG. 4 as an example, any node therein may be used as a starting point, and random sampling is performed according to the connection relationship between nodes, to obtain the plurality of first resource sequences. For example, starting from node A, the first resource sequence obtained may include A→B→C; starting from node D, the first resource sequence obtained is D→E→A.

Here, when the node relationship in the first resource graph is relatively complex, the length of the sequence obtained by sampling may be relatively long. In order to improve the consistency and accuracy of the description of the positive feedback resource feature, the length of the first resource sequence obtained by sampling may be required to be not higher than the preset length in the embodiment of the present disclosure. Here, the length of the first resource sequence may be described by the quantity of nodes included.

Step B13: text encoding is performed on first text descriptions of the plurality of first resource sequences to obtain the plurality of first sub-resource features; where the first text descriptions of the first resource sequences are constructed based on text information of resources in the first resource sequences.

Here, the first text description may be constructed from a plurality of attributes (itemid) of the positive feedback resources, and may include, for example, resource category, author, publishing time, text description of resource content, and other information.

During implementation, text descriptions of resources in the first resource sequence may be concatenated according to the order in the first resource sequence to obtain the first text description. For example, continuing to take the first resource sequence expressed as A→B→C as an example, the first text description thereof is: [text description of node A] [text description of node B] [text description of node C], where [ ] is used to separate different nodes.

In the embodiment of the present disclosure, since the positive feedback resources of the target object will gradually change over time, the first sub-resource features obtained in this way have the advantage of changing over time, and the migration of the demand of the target object can be perceived as the positive feedback resources change, so as to improve the accuracy of sorting.

Step B2: the plurality of first sub-resource features are fused to obtain the positive feedback resource feature.

During specific implementation, the weighted sum method may be used to process the plurality of first sub-resource features to obtain the positive feedback resource feature.

In addition, the plurality of first sub-resource features may be processed based on an average pooling algorithm to obtain the positive feedback resource feature. Specifically, the features with the same dimension among the plurality of first sub-resource features are averaged to obtain the positive feedback resource feature.

In the embodiment of the present disclosure, the positive feedback resource feature obtained in this way can accurately describe and characterize the short-term preference feature of the target object, so as to improve the accuracy of resource sorting.

### B) Obtaining the Negative Feedback Resource Feature

In some embodiments, the step of determining the negative feedback resource feature based on the historical operation resources may be implemented as follows.

Step C1: a plurality of second sub-resource features that the target object is not interested in are extracted from a plurality of negative feedback resources in the historical operation resources; where the negative feedback resources are resources that the target object is not interested in.

Here, negative feedback resources may be resources that the target object dislikes or browses for a short time, that is, resources of no interest.

In some embodiments, the step of extracting the plurality of second sub-resource features that the target object is not interested in from the plurality of negative feedback resources in the historical operation resources may be implemented as follows.

Step C11: a second resource graph is constructed based on the plurality of negative feedback resources, where the negative feedback resources are used as nodes in the second resource graph, and access time sequences between the negative feedback resources are used as connection edges between the nodes.

The specific operating manner is similar to the manner to obtain the first resource graph described above, and will not be described in detail here in the embodiment of the present disclosure.

Step C12: a plurality of second resource sequences are extracted from the second resource graph using a random walk strategy.

Step C13: text encoding is performed on second text descriptions of the plurality of second resource sequences to obtain the plurality of second sub-resource features; where the second text descriptions of the second resource sequences are constructed based on text information of resources in the second resource sequences.

Here, the second text description may be constructed from a plurality of attributes (itemid) of the negative feedback resources, and may include, for example, resource category, author, publishing time, text description of resource content, and other information.

During implementation, the text descriptions of the resources in the second resource sequence may be concatenated according to the order in the second resource sequence to obtain the second text description. For example, continuing to take the second resource sequence expressed as E→F→G as an example, the second text description thereof is: [text description of node E] [text description of node F] [text description of node G], where [ ] is used to separate different nodes.

In the embodiment of the present disclosure, since the negative feedback resources of the target object will gradually change over time, the second sub-resource features obtained in this way not only represent the resource preference under the target state category, but also contain an extensible trend over time, and can be adaptively adjusted as the negative feedback resources change, thereby improving the accuracy of resource recommendation.

Step C2: the plurality of second sub-resource features are fused to obtain the negative feedback resource feature.

The specific manner to obtain the negative feedback resource feature is similar to the manner to obtain the positive feedback resource feature. The weighted summation or average pooling algorithm may also be used for processing to obtain the negative feedback resource feature.

In the embodiment of the present disclosure, since the negative feedback resources of the target object will gradually change over time, the second sub-resource features obtained in this way have the advantage of changing over time, and the migration of the preference of the target object can be perceived as the negative feedback resources change, so as to improve the accuracy of sorting.

It should be noted that the dimensions of the first sub-resource feature, the second sub-resource feature, the positive feedback resource feature and the negative feedback resource feature are respectively preset dimensions. For example, the preset dimensions may be 256 dimensions.

### 3) Determining the Target State Category of the Target Object

In some embodiments, the implementation of determining the state feature of the target object is similar to the implementation of determining the candidate category feature, and may be specifically implemented as follows:

Step A1: a second environment feature and a second object feature of the target object are obtained.

Here, the second environment feature and the second object feature of the target object are time-related and are used to describe the current state of the target object. For example, the second environment feature and the second object feature of the target object within the second preset time period may be obtained. Here, the second preset time period is a shorter time period, and may be much less than the first preset time period. Exemplarily, the second preset time period may be 30 minutes or 10 minutes, may be determined based on actual conditions, and is not limited in the embodiment of the present disclosure.

Step A2: a data dimension reduction operation is performed on the second environment feature and the second object feature of the target object to obtain the state feature of the target object.

The specific dimension reduction method is similar to that described above, and will not be repeated in detail in the embodiment of the present disclosure.

In the embodiment of the present disclosure, the state feature of the target object is obtained based on the second environment feature and the second object feature of the target object, so as to accurately perceive the current state of the target object, so that the resource order can be appropriately adjusted based on the current state to improve the accuracy of resource sorting.

### 4) Adjusting the Resource Order in the Candidate Resource Set Based on the Target Resource Feature

In some embodiments, the step of adjusting the resource order in the candidate resource set of the target object based on the target resource feature of the target object associated with the target state category may be implemented as follows:

Step D1: a candidate resource feature of a candidate resource in the candidate resource set is determined.

During specific implementation, feature extraction is performed on the candidate resource to obtain an initial feature of the candidate resource; and the initial feature of the candidate resource is mapped to the preset dimension to obtain the candidate resource feature used subsequently.

Here, the candidate resource feature and the target resource feature are in the same feature space. For example, as described above, the target resource feature is determined based on the text description of the resource, and the candidate resource feature is also determined based on the text description. For the candidate resource feature and the target resource feature, the same encoding method is used for the text description.

Step D2: resource similarity between the candidate resource feature and the target resource feature is determined.

The resource similarity between the candidate resource feature and the target resource feature may be calculated using cosine similarity and Pearson Correlation Coefficient. The specific manner to calculate the resource similarity may be determined based on actual conditions, and is not limited in the embodiment of the present disclosure.

Step D3: a recommended order of the candidate resource in the candidate resource set is adjusted based on the resource similarity; where the greater the resource similarity, the greater the adjustment of the recommended order of the candidate resource in the candidate resource set.

In the embodiment of the present disclosure, the recommended order of the candidate resource in the candidate resource set is adjusted based on the resource similarity between the candidate resource feature and the target resource feature, so that the candidate resource matches the resource requirement of the target object in the current state, thereby improving the experience of the target object.

In some embodiments, the greater the similarity between the candidate resource feature of the candidate resource and a positive feedback resource feature in the target resource feature, the greater the improvement of the recommended order of the candidate resource; and the greater the similarity between the candidate resource feature of the candidate resource and a negative feedback resource feature in the target resource feature, the greater the reduction of the recommended order of the candidate resource.

During specific implementation, the greater the similarity between the candidate resource feature and the positive feedback resource feature in the target resource feature, from the perspective of similarity of resource features, the greater the influence factor for improving the order of the candidate resource corresponding to the candidate resource feature, and the nearer the front the position of the candidate resource in the recommended order may be; the greater the similarity between the candidate resource feature and the negative feedback resource feature in the target resource feature, from the perspective of similarity of resource features, the greater the influence factor for reducing the order of the candidate resource corresponding to the candidate resource feature, and the nearer the back the position of the candidate resource in the recommended order may be.

In the embodiment of the present disclosure, this method enables the obtained recommended order of the sorted candidate resources in the candidate resource set to be closer to the requirement of the target object, so as to improve the user experience.

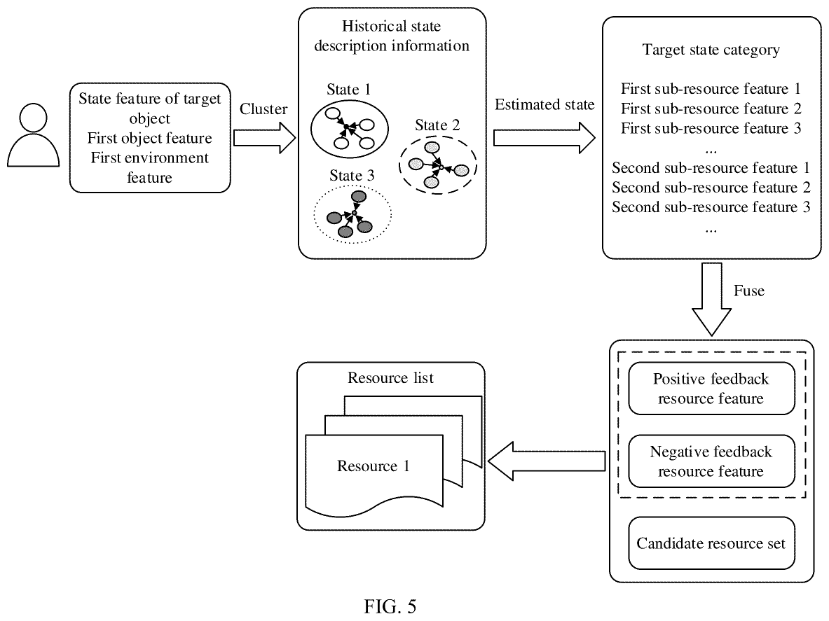

The overall framework of the method for sorting resources proposed in the embodiment of the present disclosure is shown in FIG. 5. The first object feature of the target object and the first environment feature associated with the first object feature are obtained, the historical state description information is clustered to obtain a plurality of candidate states (state 1, state 2, state 3 . . . ) of the target object, and an estimate is made based on the state feature of the target object to determine a plurality of first sub-resource features corresponding to the positive feedback resources and a plurality of second sub-resource features corresponding to the negative feedback resources under each candidate state category. The plurality of first sub-resource features are fused to obtain the positive feedback resource feature under the candidate state category, and the plurality of second sub-resource features are fused to obtain the negative feedback resource feature under the candidate state category. Subsequently, in response to the requirement of the target object, when the target state category of the target object is matched, the resource sorting of the candidate resource set is adjusted based on the positive feedback resource feature and the negative feedback resource feature under this category to obtain a final resource list.

In the information recommendation system, a plurality of resources may be screened out based on the requirement of the target object as a candidate resource set. The candidate resource set may be sorted resources, and then the method for sorting resources provided in the embodiment of the present disclosure is used to fine-tune the order, and then the resources are recommended to the target object. Based on this method, the content similar to the positive feedback under the target state category can be strengthened, and the exit of the content similar to the negative feedback can be accelerated.

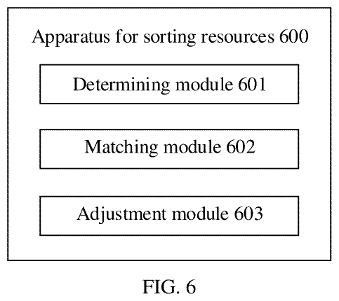

Based on the same technical concept, an embodiment of the present disclosure proposes an apparatus for sorting resources 600, as shown in FIG. 6, including:
a determining module 601 configured to determine a state feature of a target object;
a matching module 602 configured to match the state feature with a plurality of candidate state categories of the target object to obtain a matched candidate state category as a target state category; and
an adjustment module 603 configured to adjust a resource order in a candidate resource set of the target object based on a target resource feature of the target object associated with the target state category.

In some embodiments, the apparatus further includes a first obtaining module configured to:
obtain a plurality of pieces of historical state description information of the target object, where the historical state description information includes a first object feature of the target object and a first environment feature associated with the first object feature;
perform a data dimension reduction operation on the plurality of pieces of historical state description information to obtain a plurality of historical dimension reduction features; and
perform cluster analysis on the plurality of historical dimension reduction features to obtain the plurality of candidate state categories of the target object.

In some embodiments, the apparatus further includes a second obtaining module configured to:
obtain historical operation resources of the target object under the target state category within a preset time period; and
determine the target resource feature associated with the target state category based on the historical operation resources, where the target resource feature includes a positive feedback resource feature and/or a negative feedback resource feature;
where the positive feedback resource feature is used to characterize a feature of a resource that the target object is interested in; and
the negative feedback resource feature is used to characterize a feature of a resource that the target object is not interested in.

In some embodiments, the second obtaining module is specifically configured to:
extract a plurality of first sub-resource features that the target object is interested in from a plurality of positive feedback resources in the historical operation resources; where the positive feedback resources are resources that the target object is interested in; and
fuse the plurality of first sub-resource features to obtain the positive feedback resource feature.

In some embodiments, the second obtaining module is specifically configured to:
construct a first resource graph based on the plurality of positive feedback resources, where the positive feedback resources are used as nodes in the first resource graph, and access time sequences between the positive feedback resources are used as connection edges between the nodes;
extract the plurality of first resource sequences from the first resource graph using a random walk strategy; and
perform text encoding on first text descriptions of the plurality of first resource sequences to obtain the plurality of first sub-resource features; where the first text descriptions of the first resource sequences are constructed based on text information of resources in the first resource sequences.

In some embodiments, the second obtaining module is specifically configured to:
extract a plurality of second sub-resource features that the target object is not interested in from a plurality of negative feedback resources in the historical operation resources; where the negative feedback resources are resources that the target object is not interested in; and
fuse the plurality of second sub-resource features to obtain the negative feedback resource feature.

In some embodiments, the second obtaining module is specifically configured to:
construct a second resource graph based on the plurality of negative feedback resources, where the negative feedback resources are used as nodes in the second resource graph, and access time sequences between the negative feedback resources are used as connection edges between the nodes; and
extract a plurality of second resource sequences from the second resource graph using a random walk strategy; and
perform text encoding on second text descriptions of the plurality of second resource sequences to obtain the plurality of second sub-resource features; where the second text descriptions of the second resource sequences are constructed based on text information of resources in the second resource sequences.

In some embodiments, the adjustment module is configured to:
determine a candidate resource feature of a candidate resource in the candidate resource set;
determine resource similarity between the candidate resource feature and the target resource feature; and
adjust a recommended order of the candidate resource in the candidate resource set based on the resource similarity;
where the greater the resource similarity, the greater the adjustment of the recommended order of the candidate resource in the candidate resource set.

In some embodiments, the greater similarity between the candidate resource feature of the candidate resource and a positive feedback resource feature in the target resource feature, the greater improvement of the recommended order of the candidate resource; and
the greater similarity between the candidate resource feature of the candidate resource and a negative feedback resource feature in the target resource feature, the greater reduction of the recommended order of the candidate resource.

In some embodiments, the determining module is configured to:
obtain a second environment feature and a second object feature of the target object; and
perform a data dimension reduction operation on the second environment feature and the second object feature of the target object to obtain the state feature of the target object.

For the description of specific functions and examples of the modules and sub-modules of the apparatus of the embodiment of the present disclosure, reference may be made to the relevant description of the corresponding steps in the above-mentioned method embodiments, and details are not repeated here.

According to the embodiments of the present disclosure, the present disclosure also provides an electronic device, a readable storage medium and a computer program product.

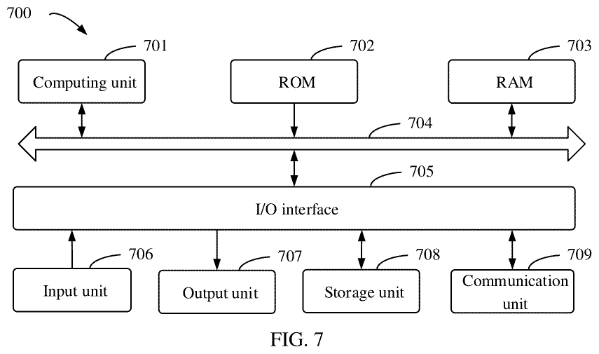

FIG. 7 shows a schematic block diagram of an exemplary electronic device 700 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 7, the device 700 includes a computing unit 701 that may perform various appropriate actions and processes according to a computer program stored in a Read-Only Memory (ROM) 702 or a computer program loaded from a storage unit 708 into a Random Access Memory (RAM) 703. Various programs and data required for an operation of device 700 may also be stored in the RAM 703. The computing unit 701, the ROM 702 and the RAM 703 are connected to each other via a bus 704. An input/output (I/O) interface 705 is also connected to the bus 704.

A plurality of components in the device 700 are connected to the I/O interface 705, and include an input unit 706 such as a keyboard, a mouse, or the like; an output unit 707 such as various types of displays, speakers, or the like; the storage unit 708 such as a magnetic disk, an optical disk, or the like; and a communication unit 709 such as a network card, a modem, a wireless communication transceiver, or the like. The communication unit 709 allows the device 700 to exchange information/data with other devices through a computer network such as the Internet and/or various telecommunication networks.

The computing unit 701 may be various general-purpose and/or special-purpose processing components with processing and computing capabilities. Some examples of the computing unit 701 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 701 performs various methods and processing described above, such as the method for sorting resources. For example, in some implementations, the method for sorting resources may be implemented as a computer software program tangibly contained in a computer-readable medium, such as the storage unit 708. In some implementations, a part or all of the computer program may be loaded and/or installed on the device 700 via the ROM 702 and/or the communication unit 709. When the computer program is loaded into the RAM 703 and executed by the computing unit 701, one or more steps of the method for sorting resources described above may be performed. Alternatively, in other implementations, the computing unit 701 may be configured to perform the method for sorting resources by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

Based on the aforementioned electronic device, the present disclosure further provides a vehicle, which may include the electronic device and may also include a communication component, a display screen for realizing a human-machine interface, and an information collection device for collecting surrounding environment information, etc. The communication component, the display screen, the information collection device and the electronic device are communicatively connected.

According to the implementations of the present disclosure, the electronic device may be integrated with the communication component, the display screen and the information collection device, or may be provided separately from the communication component, the display screen and the information collection device.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for sorting resources, comprising:
determining a state feature of a target object;
matching the state feature with a plurality of candidate state categories of the target object to obtain a matched candidate state category as a target state category; and
adjusting a resource order in a candidate resource set of the target object based on a target resource feature of the target object associated with the target state category.

2. The method of claim 1, further comprising: determining the plurality of candidate state categories of the target object by:
obtaining a plurality of pieces of historical state description information of the target object, wherein the historical state description information comprises a first object feature of the target object and a first environment feature associated with the first object feature;
performing a data dimension reduction operation on the plurality of pieces of historical state description information to obtain a plurality of historical dimension reduction features; and
performing cluster analysis on the plurality of historical dimension reduction features to obtain the plurality of candidate state categories of the target object.

3. The method of claim 1, further comprising: determining the target resource feature of the target object associated with the target state category by:
obtaining historical operation resources of the target object under the target state category within a preset time period; and
determining the target resource feature associated with the target state category based on the historical operation resources, wherein the target resource feature comprises a positive feedback resource feature and/or a negative feedback resource feature;
wherein the positive feedback resource feature is used to characterize a feature of a resource that the target object is interested in; and
the negative feedback resource feature is used to characterize a feature of a resource that the target object is not interested in.

4. The method of claim 3, wherein determining the target resource feature comprising the positive feedback resource feature comprises:
extracting a plurality of first sub-resource features that the target object is interested in from a plurality of positive feedback resources in the historical operation resources; wherein the positive feedback resources are resources that the target object is interested in; and
fusing the plurality of first sub-resource features to obtain the positive feedback resource feature.

5. The method of claim 4, wherein extracting the plurality of first sub-resource features comprises:
constructing a first resource graph based on the plurality of positive feedback resources, wherein the positive feedback resources are used as nodes in the first resource graph, and access time sequences between the positive feedback resources are used as connection edges between the nodes;
extracting a plurality of first resource sequences from the first resource graph using a random walk strategy; and
performing text encoding on first text descriptions of the plurality of first resource sequences to obtain the plurality of first sub-resource features; wherein the first text descriptions of the first resource sequences are constructed based on text information of resources in the first resource sequences.

6. The method of claim 3, wherein determining the target resource feature comprising the negative feedback resource feature comprises:
extracting a plurality of second sub-resource features that the target object is not interested in from a plurality of negative feedback resources in the historical operation resources; wherein the negative feedback resources are resources that the target object is not interested in; and
fusing the plurality of second sub-resource features to obtain the negative feedback resource feature.

7. The method of claim 6, wherein extracting the plurality of second sub-resource features comprises:
constructing a second resource graph based on the plurality of negative feedback resources, wherein the negative feedback resources are used as nodes in the second resource graph, and access time sequences between the negative feedback resources are used as connection edges between the nodes;
extracting a plurality of second resource sequences from the second resource graph using a random walk strategy; and
performing text encoding on second text descriptions of the plurality of second resource sequences to obtain the plurality of second sub-resource features; wherein the second text descriptions of the second resource sequences are constructed based on text information of resources in the second resource sequences.

8. The method of claim 1, wherein adjusting the resource order in the candidate resource set comprises:
determining a candidate resource feature of a candidate resource in the candidate resource set;
determining resource similarity between the candidate resource feature and the target resource feature; and
adjusting a recommended order of the candidate resource in the candidate resource set based on the resource similarity,
wherein the greater the resource similarity, the greater the adjustment of the recommended order of the candidate resource in the candidate resource set.

9. The method of claim 8, wherein the greater similarity between the candidate resource feature of the candidate resource and a positive feedback resource feature in the target resource feature, the greater improvement of the recommended order of the candidate resource; and
the greater similarity between the candidate resource feature of the candidate resource and a negative feedback resource feature in the target resource feature, the greater reduction of the recommended order of the candidate resource.

10. The method of claim 1, wherein determining the state feature of the target object comprises:
obtaining a second environment feature and a second object feature of the target object; and
performing a data dimension reduction operation on the second environment feature and the second object feature of the target object to obtain the state feature of the target object.

11. An electronic device, comprising:
at least one processor; and
a memory connected in communication with the at least one processor;
wherein the memory stores an instruction executable by the at least one processor, and the instruction, when executed by the at least one processor, enables the at least one processor to execute:
determining a state feature of a target object;
matching the state feature with a plurality of candidate state categories of the target object to obtain a matched candidate state category as a target state category; and
adjusting a resource order in a candidate resource set of the target object based on a target resource feature of the target object associated with the target state category.

12. The electronic device of claim 11, wherein the instruction, when executed by the at least one processor, enables the at least one processor to further execute:
determining the plurality of candidate state categories of the target object by:
obtaining a plurality of pieces of historical state description information of the target object, wherein the historical state description information comprises a first object feature of the target object and a first environment feature associated with the first object feature;
performing a data dimension reduction operation on the plurality of pieces of historical state description information to obtain a plurality of historical dimension reduction features; and
performing cluster analysis on the plurality of historical dimension reduction features to obtain the plurality of candidate state categories of the target object.

13. The electronic device of claim 11, wherein the instruction, when executed by the at least one processor, enables the at least one processor to further execute:
determining the target resource feature of the target object associated with the target state category by:
obtaining historical operation resources of the target object under the target state category within a preset time period; and
determining the target resource feature associated with the target state category based on the historical operation resources, wherein the target resource feature comprises a positive feedback resource feature and/or a negative feedback resource feature,
wherein the positive feedback resource feature is used to characterize a feature of a resource that the target object is interested in; and
the negative feedback resource feature is used to characterize a feature of a resource that the target object is not interested in.

14. The electronic device of claim 13, wherein the instruction, when executed by the at least one processor, enables the at least one processor to further execute:
determining the target resource feature comprising the positive feedback resource feature, by:
extracting a plurality of first sub-resource features that the target object is interested in from a plurality of positive feedback resources in the historical operation resources; wherein the positive feedback resources are resources that the target object is interested in; and
fusing the plurality of first sub-resource features to obtain the positive feedback resource feature.

15. The electronic device of claim 14, wherein the instruction, when executed by the at least one processor, enables the at least one processor to further execute:
extracting the plurality of first sub-resource features, by:
constructing a first resource graph based on the plurality of positive feedback resources, wherein the positive feedback resources are used as nodes in the first resource graph, and access time sequences between the positive feedback resources are used as connection edges between the nodes;
extracting a plurality of first resource sequences from the first resource graph using a random walk strategy; and
performing text encoding on first text descriptions of the plurality of first resource sequences to obtain the plurality of first sub-resource features; wherein the first text descriptions of the first resource sequences are constructed based on text information of resources in the first resource sequences.

16. A non-transitory computer-readable storage medium storing a computer instruction thereon, wherein the computer instruction is used to cause a computer to execute:
determining a state feature of a target object;
matching the state feature with a plurality of candidate state categories of the target object to obtain a matched candidate state category as a target state category; and
adjusting a resource order in a candidate resource set of the target object based on a target resource feature of the target object associated with the target state category.

17. The non-transitory computer-readable storage medium of claim 16, wherein the computer instruction is used to cause the computer to further execute:
determining the plurality of candidate state categories of the target object by:
obtaining a plurality of pieces of historical state description information of the target object, wherein the historical state description information comprises a first object feature of the target object and a first environment feature associated with the first object feature;
performing a data dimension reduction operation on the plurality of pieces of historical state description information to obtain a plurality of historical dimension reduction features; and
performing cluster analysis on the plurality of historical dimension reduction features to obtain the plurality of candidate state categories of the target object.

18. The non-transitory computer-readable storage medium of claim 16, wherein the computer instruction is used to cause the computer to further execute:
determining the target resource feature of the target object associated with the target state category is determined by:
obtaining historical operation resources of the target object under the target state category within a preset time period; and
determining the target resource feature associated with the target state category based on the historical operation resources, wherein the target resource feature comprises a positive feedback resource feature and/or a negative feedback resource feature,
wherein the positive feedback resource feature is used to characterize a feature of a resource that the target object is interested in; and
the negative feedback resource feature is used to characterize a feature of a resource that the target object is not interested in.

19. The non-transitory computer-readable storage medium of claim 18, wherein the computer instruction is used to cause the computer to further execute:
determining the target resource feature comprising the positive feedback resource feature, by:
extracting a plurality of first sub-resource features that the target object is interested in from a plurality of positive feedback resources in the historical operation resources; wherein the positive feedback resources are resources that the target object is interested in; and
fusing the plurality of first sub-resource features to obtain the positive feedback resource feature.

20. The non-transitory computer-readable storage medium of claim 19, wherein the computer instruction is used to cause the computer to further execute:
extracting the plurality of first sub-resource features, by:
constructing a first resource graph based on the plurality of positive feedback resources, wherein the positive feedback resources are used as nodes in the first resource graph, and access time sequences between the positive feedback resources are used as connection edges between the nodes;
extracting a plurality of first resource sequences from the first resource graph using a random walk strategy; and
performing text encoding on first text descriptions of the plurality of first resource sequences to obtain the plurality of first sub-resource features; wherein the first text descriptions of the first resource sequences are constructed based on text information of resources in the first resource sequences.
